(19) United States
(12) Patent Application Publication
(10) Pub. No.: US 2026/0022963 A1
(43) Pub. Date: Jan. 22, 2026

(54) INGREDIENT SUPPLY UNIT

(71) Applicant: TECHMAGIC INC., Tokyo (JP)

(72) Inventors: Shohei MAWATARI, Tokyo (JP); Eiji ISHIWATA, Tokyo (JP); Yuji SHIRAKI, Tokyo (JP)

(21) Appl. No.: 18/840,329

(22) PCT Filed: Feb. 21, 2023
(86) PCT No.: PCT/JP2023/006226

§ 371 Date: Apr. 3, 2025

(30) Foreign Application Priority Data
Feb. 22, 2022 (JP) 2022-026104

(51) Int. Cl. G01G 13/02; A47J 47/01

(52) U.S. Cl. CPC G01G 13/026; A47J 47/01

(57) ABSTRACT

Provided are an ingredient temperature maintenance and supply device and an ingredient supply unit which prevent an ingredient from spilling out from an ingredient transfer means to an ingredient metering means when a weight of the ingredient dispensed in the ingredient metering means reaches a predetermined supply weight and automatically supply the ingredient to a cooking container in a correct amount. The ingredient transfer means 213 is configured to transfer an ingredient I from an ingredient receptacle 211 to an ingredient metering means 212 until a weight of the ingredient I dispensed in the ingredient metering means 212 reaches a predetermined supply weight, the ingredient metering means 212 is configured to supply the ingredient I to a container C when a weight of the ingredient I dispensed in the ingredient metering means 212 reaches a predetermined supply weight, and an upper shutter 213d configured to adjust a transfer amount of the ingredient I to the ingredient metering means 212 on the basis of a result of metering the ingredient I by the ingredient metering means 212 is arranged between a downstream end of the ingredient transfer means 213 and the ingredient metering means 212 and configured to open and close a bottom surface opening 213a1 formed at a distal end of the ingredient transfer means 213.

### TECHNICAL FIELD

The present invention relates to an ingredient supply unit.

### BACKGROUND ART

In recent years, cooking of diverse foods with diverse food materials has been in demand in conjunction with the development of rich food cultures, while, in the food industry, there is a rapid increase in demand for cooking automation in view of circumstances, such as securing cooks, maintaining cooking skills, and improving cooking environments, and thus an automated cooking assembly for automated cooking has been more and more in demand.

As a storage device for storing an ingredient which is a component of this automated cooking assembly, there has been hitherto known a storage device comprising: a clear plastic container for holding an ingredient; a horizontally extending U-tube mounted below this plastic container; and a screw arranged in this U-tube and configured to transfer an ingredient dropped from the plastic container to a cooking container, in which the storage device is configured to dispense a plurality of types of food materials stored in the plastic container into the cooking container each in a required amount (for example, see Patent Literature 1).

### PRIOR ART DOCUMENT

### Patent Literature

Patent Literature 1: U.S. Pat. No. 10,154,762B2 (particularly, see FIG. 12 to FIG. 14)

### SUMMARY OF INVENTION

### Technical Problem

The storage device as described above has the plastic container that is open upward, which consequently poses a problem that an ingredient required to be maintained at a certain temperature cannot be stored.

Moreover, there is another problem that a lower end portion of the screw is exposed so that when the rotation of the screw is stopped after an ingredient is dispensed from the screw to the cooking container in a predetermined amount, the ingredient spills down from the lower end portion of the screw due to vibrations or the like, which hinders an automatic supply of the ingredient to the cooking container in a correct amount.

Thus, the present invention is to solve the problem of the prior art as described above. In other words, it is an object of the present invention to provide an ingredient temperature maintenance and supply device and an ingredient supply unit which prevent an ingredient from spilling out from an ingredient transfer means to an ingredient metering means when a weight of the ingredient dispensed in the ingredient metering means reaches a predetermined supply weight and automatically supply the ingredient to a cooking container in a correct amount.

### Solution to Problem

The invention according to claim 1 of the present application is to solve the above problem by an ingredient supply unit comprising: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, in which the ingredient transfer means includes: an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows an opening formed at a distal end of the ingredient transfer means to be closed to hold the ingredient or in an open state in which the opening is opened to drop and transfer the ingredient into the ingredient metering means, the upper shutter is configured to reach an open state when the shutter opening and closing mechanism is energized and reach a closed state when the shutter opening and closing mechanism is not energized, and the upper shutter is configured such that even when the ingredient is placed on a bottom portion of the upper shutter and a vertical force is applied on the bottom portion of the upper shutter, the closed state is maintained.

The invention according to claim 2 of the present application is to solve the above problem by an ingredient supply unit comprising: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, in which the ingredient metering means includes a tubular ingredient dispensing portion for temporarily storing the ingredient, the ingredient transfer means includes: an ingredient receiver attached below the ingredient receptacle and configured to extend up to above the ingredient dispensing portion; an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows a bottom surface opening of the ingredient receiver to be closed to hold the ingredient or in an open state in which the bottom surface opening is opened to drop and transfer the ingredient into the ingredient metering means, and the upper shutter includes: a first shutter plate having an arc-shaped bottom portion along the bottom surface opening of the ingredient receiver; a second shutter plate having an arc-shaped bottom portion along the bottom surface opening of the ingredient receiver; and a shutter coupling pin for coupling an upper part of the first shutter plate and an upper part of the second shutter plate to each other and axially supporting the upper part of the first shutter plate and the upper part of the second shutter plate in a rockable manner, and is configured to reach the closed state when a weight of the ingredient reaches a predetermined supply weight, so as to close the bottom surface opening of the ingredient receiver even when the ingredient is placed on the upper shutter.

The invention according to claim 3 of the present application is to solve the above problem by an ingredient supply unit comprising: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, in which the ingredient transfer means includes: an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows a distal end opening located frontward of the ingredient receptacle and opening in a transfer direction of the ingredient to be closed to hold the ingredient or in an open state in which the distal end opening is opened to drop and transfer the ingredient into the ingredient metering means, and the upper shutter is configured to reach the closed state when a weight of the ingredient reaches a predetermined supply weight, so as to close the distal end opening located frontward of the ingredient receptacle even when the ingredient is placed on the upper shutter.

The invention according to claim 4 of the present application is to further solve the above problem by, in addition to the features of the ingredient supply unit according to any one of claim 1 to claim 3, the features in which the ingredient metering means includes a lower shutter for opening and closing an ingredient supply port for supplying the ingredient to the container, the lower shutter closes the ingredient supply port to hold the ingredient in a closed state and opens the ingredient supply port to supply the ingredient to the container in an open state, and the lower shutter reaches a closed state by applying a vertical force on the lower shutter.

The invention according to claim 5 of the present application is to further solve the above problem by, in addition to the features of the ingredient supply unit according to any one of claim 1 to claim 3, the feature of being provided with a storage weight metering means for metering an ingredient stored in the ingredient receptacle and the ingredient transfer means.

The invention according to claim 6 of the present application is to further solve the above problem by the feature of comprising: an ingredient supply unit according to any one of claim 1 to claim 3; and a temperature maintenance cabinet configured to incorporate the ingredient supply unit and store the ingredient stored in the ingredient supply unit under a temperature-maintained state.

### Effects of Invention

An ingredient supply unit of the invention according to claim 1 comprises: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, whereby, to supply a predetermined amount of the ingredient to the container, the ingredient can be automatically supplied to the container in an amount required for cooking a food, while the ingredient is stored.

Further, the ingredient transfer means includes: an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows an opening formed at a distal end of the ingredient transfer means to be closed to hold the ingredient or in an open state in which the opening is opened to drop and transfer the ingredient into the ingredient metering means, the upper shutter is configured to reach an open state when the shutter opening and closing mechanism is energized and reach a closed state when the shutter opening and closing mechanism is not energized, and the upper shutter is configured such that even when the ingredient is placed on a bottom portion of the upper shutter and a vertical force is applied on the bottom portion of the upper shutter, the closed state is maintained, so that when a weight of the ingredient dispensed in the ingredient metering means reaches a predetermined supply weight, the upper shutter is closed and transfer of the ingredient to the ingredient metering means can be stopped, which can prevent the ingredient from spilling out from the ingredient transfer means to the ingredient metering means when a weight of the ingredient dispensed in the ingredient metering means reaches a predetermined supply weight, and the ingredient can be automatically supplied to the container in a correct amount, and furthermore, when the upper shutter holds the ingredient, a weight of the ingredient to hold no longer allows the upper shutter to open, so that the ingredient can be automatically supplied to the container in a correct amount.

An ingredient supply unit of the invention according to claim 2 comprises: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, whereby, to supply a predetermined amount of the ingredient to the container, the ingredient can be automatically supplied to the container in an amount required for cooking a food, while the ingredient is stored.

Further, the ingredient transfer means includes: an ingredient receiver attached below the ingredient receptacle and configured to extend up to above the ingredient dispensing portion; an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows a bottom surface opening of the ingredient receiver to be closed to hold the ingredient or in an open state in which the bottom surface opening is opened to drop and transfer the ingredient into the ingredient metering means, and the upper shutter is configured to reach the closed state when a weight of the ingredient reaches a predetermined supply weight, so as to close the bottom surface opening of the ingredient receiver even when the ingredient is placed on the upper shutter, so that when a weight of the ingredient dispensed in the ingredient metering means reaches a predetermined supply weight, the upper shutter is closed and transfer of the ingredient to the ingredient metering means can be stopped, which can prevent the ingredient from spilling out from the ingredient transfer means to the ingredient metering means when a weight of the ingredient dispensed in the ingredient metering means reaches a predetermined supply weight, and the ingredient can be automatically supplied to the container in a correct amount, and furthermore, when the upper shutter holds the ingredient, a weight of the ingredient to hold no longer allows the upper shutter to open, so that the ingredient can be automatically supplied to the container in a correct amount.

Moreover, the upper shutter includes: a first shutter plate having an arc-shaped bottom portion along the bottom surface opening of the ingredient receiver; a second shutter plate having an arc-shaped bottom portion along the bottom surface opening of the ingredient receiver; and a shutter coupling pin for coupling an upper part of the first shutter plate and an upper part of the second shutter plate to each other and axially supporting the upper part of the first shutter plate and the upper part of the second shutter plate in a rockable manner, so that in the process from a closed state to an open state, the first shutter plate and the second shutter plate of the upper shutter move along the bottom surface opening of the ingredient receiver, which can consequently scrape off the ingredient sticking to the upper shutter by means of the ingredient receiver.

An ingredient supply unit of the invention according to claim 3 comprises: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, whereby, to supply a predetermined amount of the ingredient to the container, the ingredient can be automatically supplied to the container in an amount required for cooking a food, while the ingredient is stored.

Further, the ingredient transfer means includes: an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows a distal end opening located frontward of the ingredient receptacle and opening in a transfer direction of the ingredient to be closed to hold the ingredient or in an open state in which the distal end opening is opened to drop and transfer the ingredient into the ingredient metering means, and the upper shutter is configured to reach the closed state when a weight of the ingredient reaches a predetermined supply weight, so as to close the distal end opening located frontward of the ingredient receptacle even when the ingredient is placed on the upper shutter, so that when a weight of the ingredient dispensed in the ingredient metering means reaches a predetermined supply weight, the upper shutter is closed and transfer of the ingredient to the ingredient metering means can be stopped, which can prevent the ingredient from spilling out from the ingredient transfer means to the ingredient metering means when a weight of the ingredient dispensed in the ingredient metering means reaches a predetermined supply weight, and the ingredient can be automatically supplied to the container in a correct amount, and furthermore, when the upper shutter holds the ingredient, a weight of the ingredient to hold no longer allows the upper shutter to open, so that the ingredient can be automatically supplied to the container in a correct amount.

According to an ingredient supply unit of the invention according to claim 4, in addition to the effects produced by the ingredient supply unit of the invention according to any one of claim 1 to claim 3, the lower shutter reaches a closed state by applying a vertical force on the lower shutter, so that even when a dead weight of an ingredient is applied on the lower shutter while the lower shutter holds the ingredient, the lower shutter does not reach an open state, and thus the ingredient can be reliably held by the lower shutter.

According to an ingredient supply unit of the invention according to claim 5, in addition to the effects produced by the ingredient supply unit of the invention according to any one of claim 1 to claim 3, there is provided a storage weight metering means for metering an ingredient stored in the ingredient receptacle and the ingredient transfer means, so that a weight of the ingredient stored in the ingredient receptacle and the ingredient transfer means can be determined, and thus timing of loading an ingredient into the ingredient receptacle can be suitably managed.

According to an ingredient temperature maintenance and supply unit of the invention according to claim 6, in addition to the effects produced by the ingredient supply unit of the invention according to any one of claim 1 to claim 3, an ingredient maintained at a certain temperature is supplied to the container in a predetermined amount, and thus the ingredient can be automatically supplied to the container in an amount required for cooking a food, while the ingredient is maintained and stored at a suitable temperature.

### BRIEF DESCRIPTION OF DRAWINGS

FIG. 1 is a perspective view of an ingredient supply assembly provided with an ingredient temperature maintenance and supply device according to an embodiment of the present invention as seen from the front.

FIG. 2 is a perspective view of the ingredient supply assembly as illustrated in FIG. 1 as seen from the back.

FIG. 3 is a configuration diagram of the ingredient supply assembly as illustrated in FIG. 1.

FIG. 4 is a perspective view of a first ingredient supply unit as illustrated in FIG. 2.

FIG. 5 is a cross-sectional view taken along V-V of FIG. 4.

FIG. 6 is a cross-sectional view taken along VI-VI of FIG. 5.

FIG. 7 is a cross-sectional view taken along VII-VII of FIG. 5.

FIG. 8A is a cross-sectional view illustrating a state in which a first ingredient supply unit stores an ingredient.

FIG. 8B is a cross-sectional view illustrating a state in which in the first ingredient supply unit, an ingredient is transferred to an ingredient transfer means.

FIG. 8C is a cross-sectional view illustrating a state in which in the first ingredient supply unit, an ingredient is transferred by the ingredient transfer means.

FIG. 8D is a cross-sectional view illustrating a state in which in the first ingredient supply unit, an ingredient is dispensed into an ingredient dispensing portion.

FIG. 8E is a cross-sectional view illustrating a state in which in the first ingredient supply unit, an ingredient is supplied to a container.

FIG. 9 is a perspective view of a second ingredient supply unit at an ingredient storage position as illustrated in FIG. 2.

FIG. 10 is a cross-sectional view taken along X-X of FIG. 9.

FIG. 11 is an enlarged left side view of a principal part of FIG. 9.

FIG. 12 is an enlarged right side view of a principal part of FIG. 9.

FIG. 13A is a cross-sectional view illustrating a state in which a second ingredient supply unit stores an ingredient.

FIG. 13B is a cross-sectional view illustrating a state in which in the second ingredient supply unit, an ingredient is dispensed into an ingredient dispensing portion.

FIG. 13C is a cross-sectional view illustrating a state in which in the second ingredient supply unit, an ingredient is supplied to a container.

### DESCRIPTION OF EMBODIMENTS

The present invention may be embodied in any way as long as an ingredient supply unit comprises: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, in which the ingredient transfer means includes: an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows an opening formed at a distal end of the ingredient transfer means to be closed to hold the ingredient or in an open state in which the opening is opened to drop and transfer the ingredient into the ingredient metering means, the upper shutter is configured to reach an open state when the shutter opening and closing mechanism is energized and reach a closed state when the shutter opening and closing mechanism is not energized, and the upper shutter is configured such that even when the ingredient is placed on a bottom portion of the upper shutter and a vertical force is applied on the bottom portion of the upper shutter, the closed state is maintained, whereby the ingredient supply unit prevents the ingredient from spilling out from the ingredient transfer means to the ingredient metering means when a weight of the ingredient dispensed in the ingredient metering means reaches a predetermined supply weight, and automatically supplies the ingredient to the container in a correct amount.

Further, the present invention may be embodied in any way as long as an ingredient supply unit comprises: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, in which the ingredient metering means includes a tubular ingredient dispensing portion for temporarily storing the ingredient, the ingredient transfer means includes: an ingredient receiver attached below the ingredient receptacle and configured to extend up to above the ingredient dispensing portion; an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows a bottom surface opening of the ingredient receiver to be closed to hold the ingredient or in an open state in which the bottom surface opening is opened to drop and transfer the ingredient into the ingredient metering means, and the upper shutter includes: a first shutter plate having an arc-shaped bottom portion along the bottom surface opening of the ingredient receiver; a second shutter plate having an arc-shaped bottom portion along the bottom surface opening of the ingredient receiver; and a shutter coupling pin for coupling an upper part of the first shutter plate and an upper part of the second shutter plate to each other and axially supporting the upper part of the first shutter plate and the upper part of the second shutter plate in a rockable manner, and is configured to reach the closed state when a weight of the ingredient reaches a predetermined supply weight, so as to close the bottom surface opening of the ingredient receiver even when the ingredient is placed on the upper shutter, whereby the ingredient supply unit prevents the ingredient from spilling out from the ingredient transfer means to the ingredient metering means when a weight of the ingredient dispensed in the ingredient metering means reaches a predetermined supply weight, and automatically supplies the ingredient to the container in a correct amount.

Moreover, the present invention may be embodied in any way as long as an ingredient supply unit comprising: an ingredient receptacle for storing an ingredient; an ingredient metering means for dispensing and metering the ingredient; and an ingredient transfer means for transferring an ingredient stored in the ingredient receptacle to the ingredient metering means, wherein until a weight of the ingredient dispensed in the ingredient metering means reaches a predetermined supply weight, the ingredient transfer means is configured to transfer the ingredient from the ingredient receptacle to the ingredient metering means, and when a weight of the ingredient dispensed in the ingredient metering means reaches a predetermined supply weight, the ingredient metering means is configured to supply the ingredient to a container, in which the ingredient transfer means includes: an upper shutter arranged between a downstream end of the ingredient transfer means and the ingredient metering means and configured to adjust a transfer amount of the ingredient from the ingredient transfer means to the ingredient metering means on the basis of a result of metering the ingredient by the ingredient metering means; and a shutter opening and closing mechanism for controlling opening and closing of the upper shutter in such a manner as to be in a closed state in which a dead weight of the upper shutter allows a distal end opening located frontward of the ingredient receptacle and opening in a transfer direction of the ingredient to be closed to hold the ingredient or in an open state in which the distal end opening is opened to drop and transfer the ingredient into the ingredient metering means, and the upper shutter is configured to reach the closed state when a weight of the ingredient reaches a predetermined supply weight, so as to close the distal end opening located frontward of the ingredient receptacle even when the ingredient is placed on the upper shutter, whereby the ingredient supply unit prevents the ingredient from spilling out from the ingredient transfer means to the ingredient metering means when a weight of the ingredient dispensed in the ingredient metering means reaches a predetermined supply weight, and automatically supplies the ingredient to the container in a correct amount.

For example, the ingredient temperature maintenance and supply device provided with the ingredient supply unit according to the present invention is mainly installed in a restaurant store, but an installation location of the ingredient temperature maintenance and supply device according to the present invention is not limited to this and may include a food court, an office, a family house, etc.

For example, the temperature to maintain for an ingredient by the ingredient temperature maintenance and supply device provided with the ingredient supply unit according to the present invention may be less than or equal to zero degree, about four degrees or any degree of temperature.

For example, an ingredient stored in the ingredient temperature maintenance and supply device provided with the ingredient supply unit according to the present invention may be any food, such as rice, noodles, vegetables, fish, grains, and various seasonings.

For example, the ingredient supply unit according to the present invention may be partially incorporated in the temperature maintenance cabinet, partially exposed out of the temperature maintenance cabinet or entirely incorporated in the temperature maintenance cabinet.

### EMBODIMENTS

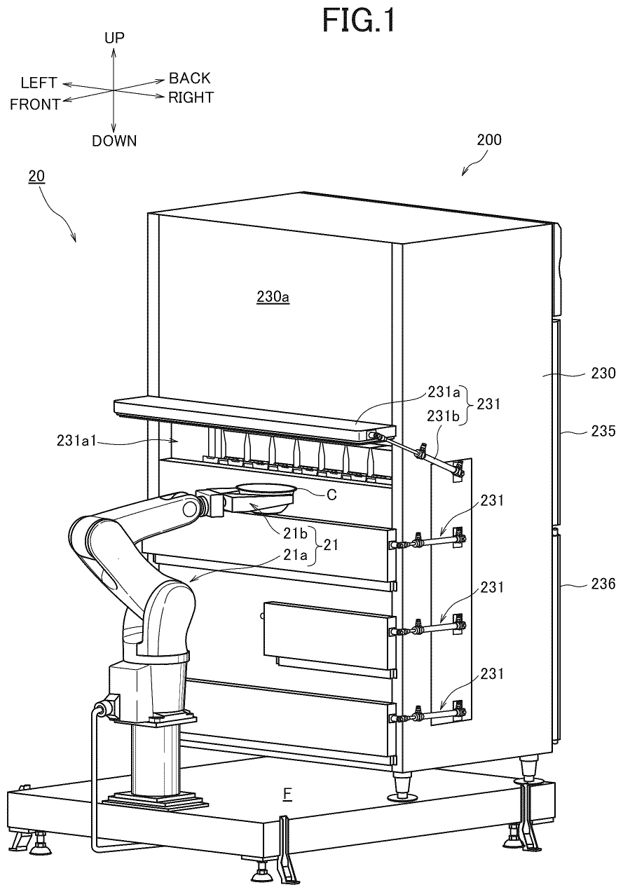

Next, an ingredient supply assembly 20 provided with an ingredient temperature maintenance and supply device 200 according to an embodiment of the present invention will be described with reference to FIG. 1 to FIG. 13C.

### <1. Summary of Ingredient Supply Assembly>

First, a summary of the ingredient supply assembly 20 will be provided with reference to FIG. 1 to FIG. 3.

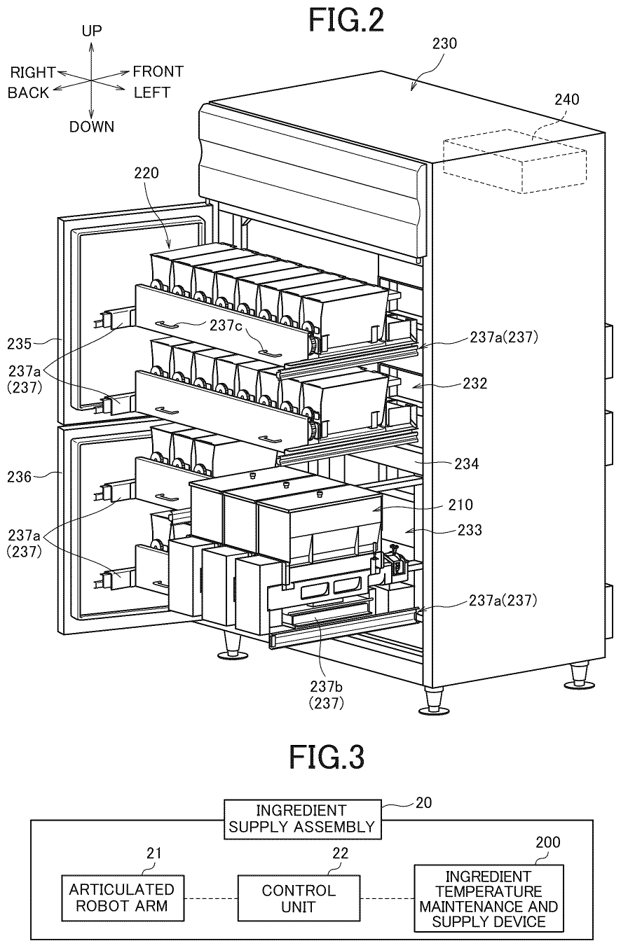

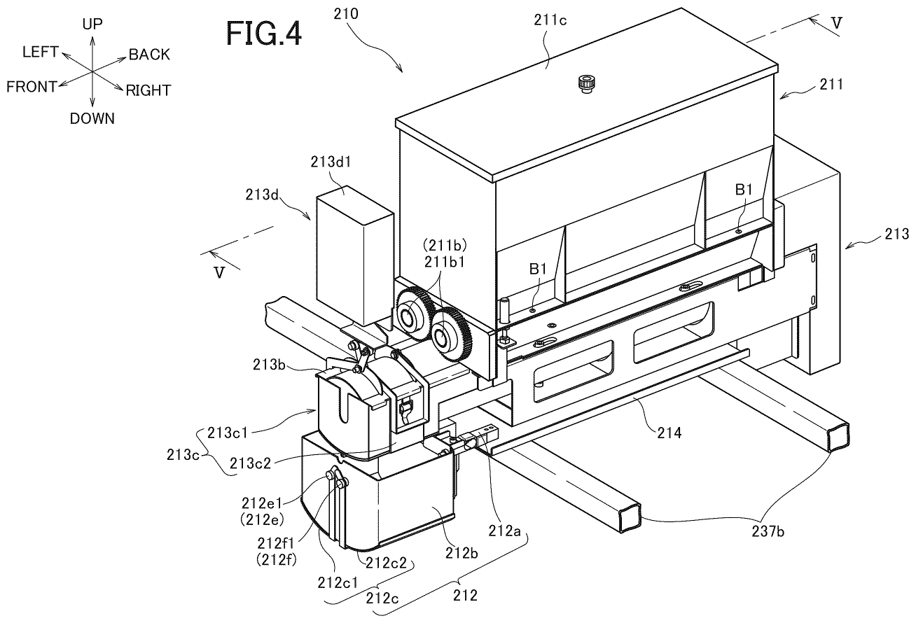

Then, FIG. 1 is a perspective view of an ingredient supply assembly provided with an ingredient temperature maintenance and supply device according to an embodiment of the present invention as seen from the front, FIG. 2 is a perspective view of the ingredient supply assembly as illustrated in FIG. 1 as seen from the back, and FIG. 3 is a configuration diagram of the ingredient supply assembly as illustrated in FIG. 1.

Note that in FIG. 2, an upper door 235 and a lower door 236 on one side of the ingredient temperature maintenance and supply device 200 are omitted for the sake of explanation.

As illustrated in FIG. 1 to FIG. 3, the ingredient supply assembly 20 includes: the ingredient temperature maintenance and supply device 200 placed on a floor surface F and configured to store an ingredient at a maintained temperature; an articulated robot arm 21 for holding and carrying a container C; and a control unit 22 configured to perform at least drive control of the ingredient temperature maintenance and supply device 200 and the articulated robot arm 21 (see FIG. 3).

As illustrated in FIG. 1, the articulated robot arm 21 is placed on the floor surface F and has a five-axis robot arm body 21a and a container holding mechanism 21b coupled to a distal end of this robot arm body 21a and configured to hold the container C.

### <2. Summary of Ingredient Temperature Maintenance and Supply Device>

Next, a summary of the ingredient temperature maintenance and supply device 200 will be provided with reference to FIG. 1 and FIG. 2.

As illustrated in FIG. 1 and FIG. 2, the ingredient temperature maintenance and supply device 200 is placed in an area backward of the articulated robot arm 21.

As illustrated in FIG. 1 and FIG. 2, this ingredient temperature maintenance and supply device 200 includes: an ingredient supply unit (a first ingredient supply unit 210, a second ingredient supply unit 220) for supplying a stored ingredient to the container C held by the articulated robot arm 21; a cuboidal temperature maintenance cabinet 230 for housing this ingredient supply unit and storing an ingredient stored in the ingredient supply unit under a temperature-maintained state; and a controller 240 for controlling the first ingredient supply unit 210, the second ingredient supply unit 220, and the temperature maintenance cabinet 230.

As illustrated in FIG. 2, a number of ingredient supply units are arranged in an up-down direction and a left-right direction and provided for each kind of ingredients.

Note that an ingredient supply port 212b2 of the first ingredient supply unit 210 and an ingredient supply port 222b1 of the second ingredient supply unit 220 as described below are each placed in a moveable range of the articulated robot arm 21.

As illustrated in FIG. 1, the temperature maintenance cabinet 230 is placed on the floor surface F and has a front wall (outer surface) 230a provided with a number of rectangular openings 230al.

Then, these openings 230a1 are closable by rotation of a front door 231 in the up-down direction.

The front door 231 includes a door body 231a rotatable relative to the front wall 230a and a door rotating mechanism 231b for rotating this door body 231a in the up-down direction.

Further, as illustrated in FIG. 2, the temperature maintenance cabinet 230 is provided with a partition plate 234 for partitioning the interior of the temperature maintenance cabinet 230 into an above upper accommodating chamber 232 and a below lower accommodating chamber 233.

Moreover, as illustrated in FIG. 1 and FIG. 2, the temperature maintenance cabinet 230 is provided with the upper door 235 for allowing the upper accommodating chamber 232 to be closable and the lower door 236 for allowing the lower accommodating chamber 233 to be closable.

Then, the upper accommodating chamber 232 and the lower accommodating chamber 233 of this temperature maintenance cabinet 230 are provided with a slide mechanism 237 configured to be drawable relative to the temperature maintenance cabinet 230.

As illustrated in FIG. 2, the slide mechanism 237 includes: an unillustrated temperature maintenance cabinet-side rail attached to the temperature maintenance cabinet 230 and configured to extend in a front-back direction; a supply unit-side rail 237a configured to be slidable relative to this temperature maintenance cabinet-side rail in the front-back direction; a frame 237b attached to this supply unit-side rail 237a, the supply unit being placed on the frame 237b; and a handle 237c for drawing this frame 237b.

### <3. Configuration of First Ingredient Supply Unit>

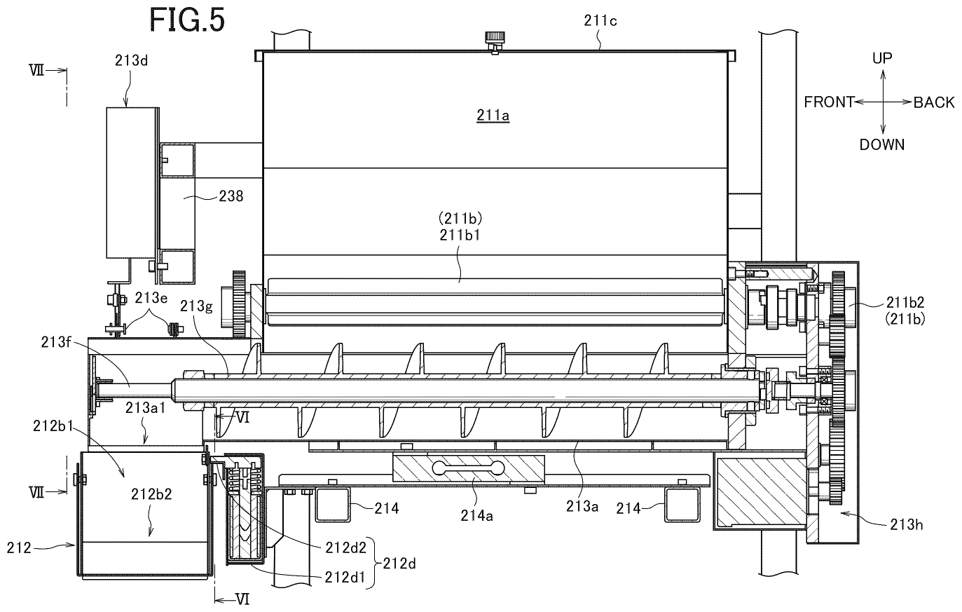

Next, a configuration of the first ingredient supply unit 210 will be described with reference to FIG. 2, FIG. 4 to FIG. 7, etc.

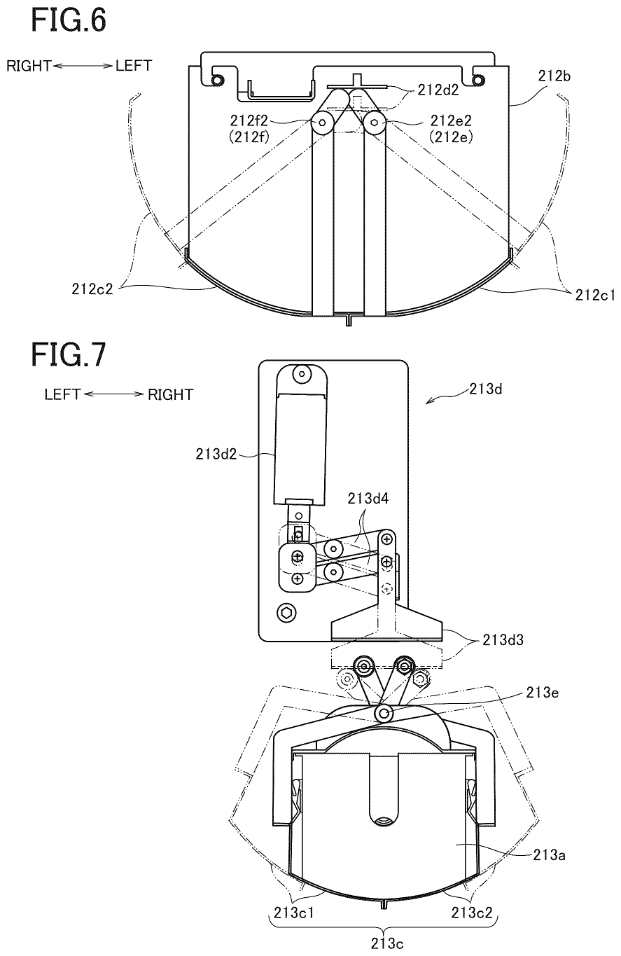

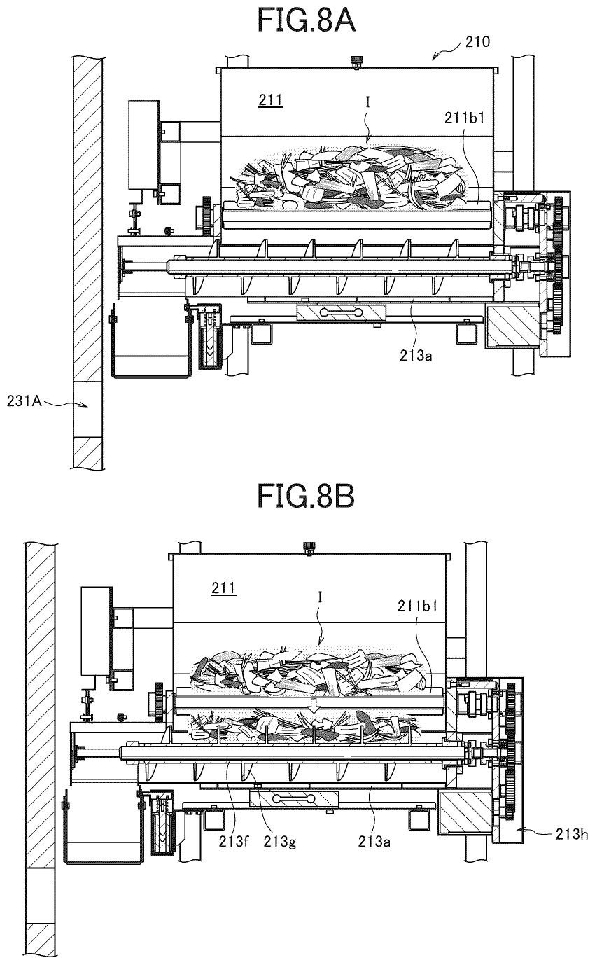

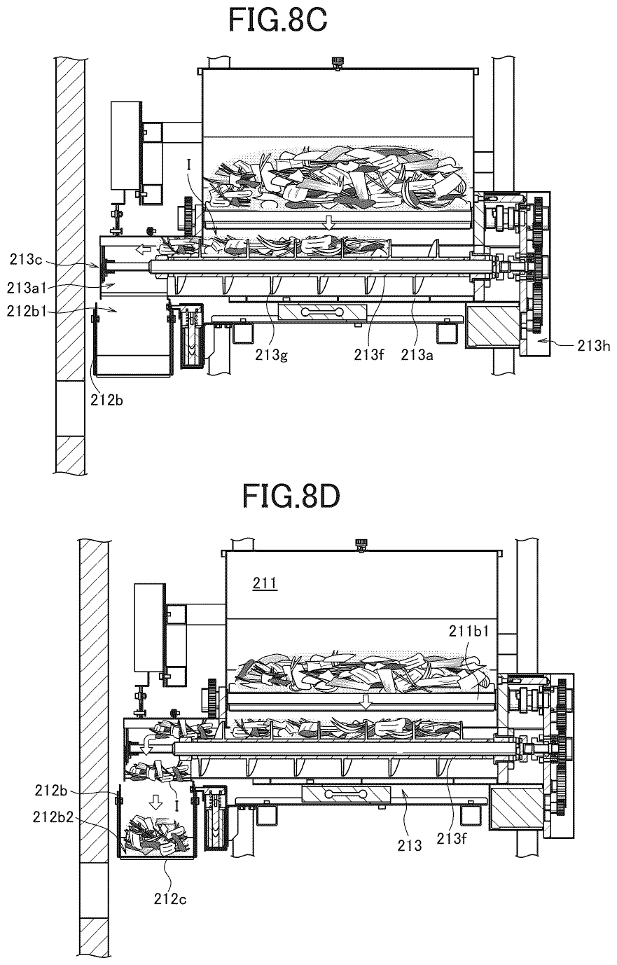

FIG. 4 is a perspective view of a first ingredient supply unit as illustrated in FIG. 2, FIG. 5 is a cross-sectional view taken along V-V of FIG. 4, FIG. 6 is a cross-sectional view taken along VI-VI of FIG. 5, and FIG. 7 is a cross-sectional view taken along VII-VII of FIG. 5.

Note that in FIG. 5, the front wall 230a of the temperature maintenance cabinet 230 and the frame 237b of the slide mechanism 237 are omitted for the sake of explanation.

Further, in FIG. 7, an exterior cover 213d1 of a shutter opening and closing mechanism 213d is omitted for the sake of explanation.

As is clear from FIG. 2, the first ingredient supply unit 210 is provided in the interior of the temperature maintenance cabinet 230.

Then, as illustrated in FIG. 4, FIG. 5, etc., this first ingredient supply unit 210 includes: an ingredient receptacle 211 provided in the interior of the temperature maintenance cabinet 230 (a lower accommodating chamber 233) and configured to store an ingredient; an ingredient metering means 212 for dispensing and metering an ingredient; an ingredient transfer means 213 for transferring an ingredient stored in the ingredient receptacle 211 to the ingredient metering means 212; and a rack 214 placed on the slide mechanism 237 (see FIG. 2) provided in the interior of the temperature maintenance cabinet 230 (the lower accommodating chamber 233), the ingredient transfer means 213 being placed on the rack 214.

Thus, the temperature of an ingredient stored in the ingredient receptacle 211 is maintained by the temperature maintenance cabinet 230.

Further, the entirety of the first ingredient supply unit 210 is drawable relative to the temperature maintenance cabinet 230 in the front-back direction, and the first ingredient supply unit 210 may be drawn further backward than the temperature maintenance cabinet 230 up to an ingredient loading position as illustrated in FIG. 2, so that an ingredient to load can be loaded into the ingredient receptacle 211.

### <3.1. Ingredient Receptacle>

As illustrated in FIG. 5, the ingredient receptacle 211 includes: a prismatic receptacle body 211a for storing an ingredient; an ingredient transfer auxiliary mechanism 211b provided at a bottom portion of this receptacle body 211a and configured to transfer an ingredient to the ingredient transfer means 213; and a detachable lid 211c for closing an upper opening formed in the receptacle body 211a.

As illustrated in FIG. 4 and FIG. 5, the ingredient transfer auxiliary mechanism 211b includes a bladed shaft 211b1 configured to penetrate through the interior of the receptacle body 211a and a gear 211b2 mounted on a back end of this bladed shaft 211b1.

As illustrated in FIG. 4, the two bladed shaft 211b1 are provided to the receptacle body 211a and rotate in conjunction with each other by means of engagement and rotation of gears on a front end side.

Further, this bladed shaft 211b1 has three blade portions configured to radially project, is coupled to a screw drive mechanism 231h as described below, and is rotatable by means of rotation of the screw drive mechanism 213h.

### <3.2. Ingredient Metering Means>

As illustrated in FIG. 4 and FIG. 5, the ingredient metering means 212 includes: a load cell 212a having a back end attached to the rack 214; a prismatic ingredient dispensing portion 212b to which a front end of this load cell 212a is attached, the prismatic ingredient dispensing portion 212b being configured to temporarily store an ingredient; a lower shutter 212c for opening and closing the ingredient supply port 212b2 of this ingredient dispensing portion 212b; and a shutter opening and closing mechanism 212d for controlling opening and closing of this lower shutter 212c.

As illustrated in FIG. 4, the load cell 212a is configured to extend in the front-back direction and detect a weight of the ingredient dispensing portion 212b.

As illustrated in FIG. 5, the ingredient dispensing portion 212b has an upper opening 212b1 which faces a bottom surface opening 213a1 of the ingredient transfer means 213 as described below, and is formed to be somewhat larger than this bottom surface opening 213a1 in plan view.

As illustrated in FIG. 4 and FIG. 6, the lower shutter 212c includes a left shutter 212c1 and a right shutter 212c2 and is configured to close the ingredient supply port 212b2 at a lower portion of the ingredient dispensing portion 212b by means of these two shutters.

The left shutter 212c1 is axially supported at a front surface and a back surface of the ingredient dispensing portion 212b using a left coupling pin 212e.

Specifically, as illustrated in FIG. 4, a front side of the left shutter 212c1 is coupled to a front surface of the ingredient dispensing portion 212b using a left-front coupling pin 212e1 and as illustrated in FIG. 6, a back side of the left shutter 212c1 is coupled to a back surface of the ingredient dispensing portion 212b using a left-back coupling pin 212e2.

This left shutter 212c1 includes: an arc-shaped bottom portion along the ingredient supply port 212b2 of the ingredient dispensing portion 212b; an arm portion configured to rise up in a vertical direction from a front end and a back end of this bottom portion; and an inclined portion configured to extend obliquely from an upper end of this arm portion toward the right shutter 212c2.

Note that as illustrated in FIG. 4 and FIG. 6, the left coupling pin 212e is configured to penetrate substantially a boundary between the arm portion and the inclined portion of the left shutter 212c1.

As illustrated in FIG. 6, etc., the right shutter 212c2 is a member symmetrical to the left shutter 212c1 and is axially supported at a front surface and a back surface of the ingredient dispensing portion 212b using a right coupling pin 212f.

Specifically, as illustrated in FIG. 4, a front side of the right shutter 212c2 is coupled to a front surface of the ingredient dispensing portion 212b using a right-front coupling pin 212f1 and as illustrated in FIG. 6, a back side of the right shutter 212c2 is coupled to a back surface of the ingredient dispensing portion 212b using a right-back coupling pin 212f2.

As illustrated in FIG. 5, the shutter opening and closing mechanism 212d includes: a pull-type solenoid 212d1, which is configured to retract in an energized state and extend in a non-energized state, attached backward of the ingredient dispensing portion 212b and having a plunger configured to extend and retract in an up-down direction; and a push-down member 212d2 configured to abut an inclined portion of the left shutter 212c1 and an inclined portion of the right shutter 212c2 in accordance with movement of this plunger of the solenoid 212d1.

Then, this shutter opening and closing mechanism 212d allows the plunger of the solenoid 212d1 to extend and retract, thereby rotating the left shutter 212c1 and the right shutter 212c2 which are coupled to the solenoid 212d1.

Specifically, when the plunger of the solenoid 212d1 extends, then the push-down member 212d2 ascends, which results in a closed state in which a dead weight of the left shutter 212c1 and the right shutter 212c2, the dead weight being a vertical force, allows the ingredient supply port 212b2 to be closed to hold an ingredient.

On the other hand, when the plunger of the solenoid 212d1 retracts, then the push-down member 212d2 descends, which results in an open state in which the left shutter 212c1 and the right shutter 212c2 allow the ingredient supply port 212b2 to be opened.

### <3.3. Ingredient Transfer Means>

As illustrated in FIG. 4 and FIG. 5, the ingredient transfer means 213 includes: an ingredient receiver 213a attached below the receptacle body 211a and configured to extend up to above the ingredient dispensing portion 212b; a lid 213b for covering from above a distal end side of the ingredient receiver 213a which is open above; an upper shutter 213c for opening and closing a bottom surface opening (opening) 213a1 of the ingredient receiver 213a on the distal side; and a shutter opening and closing mechanism 213d for controlling opening and closing of this upper shutter 213c.

Further, as illustrated in FIG. 5, this ingredient transfer means 213 includes a screw shaft 213f configured to penetrate through the interior of the ingredient receiver 213a in the front-back direction, a spiral blade 213g attached to this screw shaft 213f, and a screw drive mechanism 213h for rotating the screw shaft 213f.

As illustrated in FIG. 4, the ingredient receiver 213a is attached to the ingredient receptacle 211 using a coupling bolt B1.

The upper shutter 213c is arranged between a downstream end side of the ingredient receiver 213a of the ingredient transfer means 213 and the ingredient metering means 212 and as illustrated in FIG. 4, includes a left shutter (first shutter plate) 213c1 and a right shutter (second shutter plate) 213c2 and is configured to close the bottom surface opening 213a1 (see FIG. 5) of the ingredient receiver 213a on the distal end side by means of these two shutters.

As illustrated in FIG. 4 and FIG. 7, the left shutter 213c1 includes: an arc-shaped bottom portion along the bottom surface opening 213a1 of the ingredient receiver 213a; a vertical arm portion configured to rise up in the vertical direction from a left end of this bottom portion; a horizontal arm portion configured to extend from an upper end of this vertical arm portion along the lid 213b and toward the right shutter 213c2; and an inclined portion configured to extend obliquely upward from this horizontal arm portion.

As illustrated in FIG. 7, etc., the right shutter 213c2 is symmetrical to the left shutter 213c1.

Then, the left shutter 213c1 and the right shutter 213c2 are coupled to each other by means of a shutter coupling pin 213e.

As illustrated in FIG. 4, etc., this shutter coupling pin 213e is configured to penetrate substantially a boundary between the horizontal arm portion and the inclined portion of the left shutter 213c1 and the right shutter 213c2 as well as the lid 213b.

Thus, the left shutter 213c1 and the right shutter 213c2 are attached to the lid 213b and axially supported by means of the shutter coupling pin 213e.

As illustrated in FIG. 5, the shutter opening and closing mechanism 213d is attached to a fixing frame 238 of the temperature maintenance cabinet 230.

Then, this shutter opening and closing mechanism 213d includes: the exterior cover 213d1 as illustrated in FIG. 4; a pull-type solenoid 213d2 having a plunger configured to extend and retract in the up-down direction; a push-down member 213d3 configured to abut an inclined portion of the left shutter 213c1 and an inclined portion of the right shutter 213c2; and a link 213d4 for transmitting movement of the plunger of the solenoid 213d2 to the push-down member 213d3 as illustrated in FIG. 7.

The shutter opening and closing mechanism 213d thus configured allows the plunger of the solenoid 213d2 to extend and retract, whereby the push-down member 213d3 vertically moves by means of the link 213d4 so as to rotate the left shutter 213c1 and the right shutter 213c2.

Specifically, when the plunger of the solenoid 213d2 extends, then the link 213d4 allows the push-down member 213d3 to ascend, which results in a closed state in which a dead weight of the left shutter 213c1 and the right shutter 213c2 allows the bottom surface opening 213a1 to be closed to hold an ingredient.

The configuration of the upper shutter 213c as described above allows this closed state to be maintained even when an ingredient is placed on a bottom portion of the upper shutter 213c and a vertical force is applied on the bottom portion of the upper shutter 213c.

On the other hand, when the plunger of the solenoid 213d2 retracts, then the link 213d4 allows the push-down member 213d3 to descend, which results in an open state in which the left shutter 213c1 and the right shutter 213c2 allow the bottom surface opening 213a1 to be opened.

Note that this shutter opening and closing mechanism 213d is driven on the basis of a result of metering an ingredient by the ingredient metering means 212.

In other words, the upper shutter 213c adjusts a transfer amount of an ingredient to the ingredient metering means 212 on the basis of a result of metering an ingredient by the ingredient metering means 212.

### <3.4. Rack>

As illustrated in FIG. 5, the rack 214 is provided with a load cell (storage weight metering means) 214a for metering a weight of an ingredient I stored in the ingredient receptacle 211 and the ingredient transfer means 213.

Note that the first ingredient supply unit 210 may be provided with a notification means (for example, an alarm) or a display means (for example, a display) for communicating that a weight of the ingredient I stored in the ingredient receptacle 211 and the ingredient transfer means 213 becomes less than or equal to a predetermined weight on the basis of the load cell 214a.

### <4. Ingredient Supply Process Through First Ingredient Supply Unit>

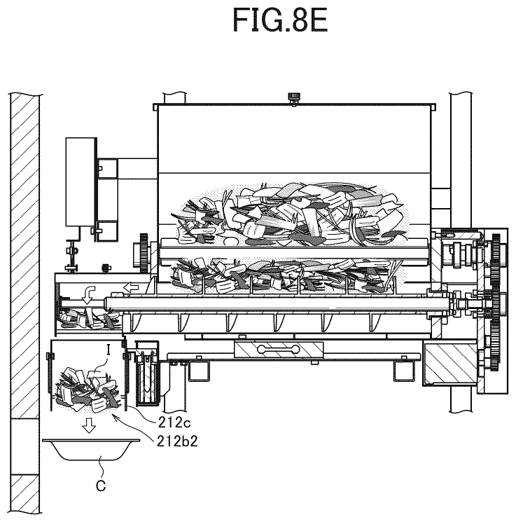

Next, an example of an ingredient supply process through the first ingredient supply unit 210 will be described with reference to FIG. 8A to FIG. 8E, etc.

FIG. 8A is a cross-sectional view illustrating a state in which a first ingredient supply unit stores an ingredient, FIG. 8B is a cross-sectional view illustrating a state in which in the first ingredient supply unit, an ingredient is transferred to an ingredient transfer means, FIG. 8C is a cross-sectional view illustrating a state in which in the first ingredient supply unit, an ingredient is transferred by the ingredient transfer means, FIG. 8D is a cross-sectional view illustrating a state in which in the first ingredient supply unit, an ingredient is dispensed into an ingredient dispensing portion, and FIG. 8E is a cross-sectional view illustrating a state in which in the first ingredient supply unit, an ingredient is supplied to a container.

Note that the ingredient supply process as described below is merely an example, and an ingredient supply process through the first ingredient supply unit 210 is not to be limited to this example.

As illustrated in FIG. 8A, the ingredient receptacle 211 of the first ingredient supply unit 210 stores the ingredient I.

From this state, the bladed shaft 211b1 of the ingredient receptacle 211 is rotated, whereby as illustrated in FIG. 8B, the ingredient I is transferred to the ingredient receiver 213a.

From this state, the screw shaft 213f is rotated by the screw drive mechanism 213h to rotate the blade 213g, whereby as illustrated in FIG. 8C, the ingredient I is transferred toward a distal end of the ingredient receiver 213a.

While the ingredient I is transferred toward the distal end of the ingredient receiver 213a, as illustrated in FIG. 8C, the upper shutter 213c of the ingredient transfer means 213 is open, and the bottom surface opening 213a1 of the ingredient receiver 213a and the upper opening 212b1 of the ingredient dispensing portion 212b communicate with each other.

Thus, while the bladed shaft 211b1 of the ingredient receptacle 211 and the screw shaft 213f of the ingredient transfer means 213 continue to rotate, as illustrated in FIG. 8D, the ingredient I is successively transferred to the ingredient dispensing portion 212b of the ingredient metering means 212 with the ingredient supply port 212b2 closed by the lower shutter 212c.

Then, until a weight of the ingredient I dispensed in the ingredient dispensing portion 212b of the ingredient metering means 212 reaches a predetermined weight, the ingredient transfer means 213 transfers the ingredient I to the ingredient dispensing portion 212b of the ingredient metering means 212, and when a weight of the ingredient I dispensed in the ingredient dispensing portion 212b reaches a supply weight according to a certain food, transfer of the ingredient I to the ingredient transfer means 213 by the ingredient transfer auxiliary mechanism 211b of the ingredient receptacle 211 is stopped, rotation of the screw shaft 213f of the ingredient transfer means 213 is stopped, and the upper shutter 213c of the ingredient transfer means 213 is closed so as to close the bottom surface opening 213a1 of the ingredient receiver 213a.

Thereby, transfer of the ingredient I to the ingredient metering means 212 is interrupted.

Further, in addition to the behavior of the first ingredient supply unit 210 as described above, the control unit 22 in advance allows the articulated robot arm 21 to move the container C up to directly below the ingredient supply port 212b2 of the ingredient metering means 212.

Then, as illustrated in FIG. 8E, the control unit 22 allows the lower shutter 212c of the ingredient metering means 212 to open so as to open the ingredient supply port 212b2 of the ingredient metering means 212, and then from the ingredient supply port 212b2 of the ingredient dispensing portion 212b, the ingredient I having a supply weight according to a certain food is supplied to the container C located directly below the ingredient supply port 212b2.

### <5. Configuration of Second Ingredient Supply Unit>

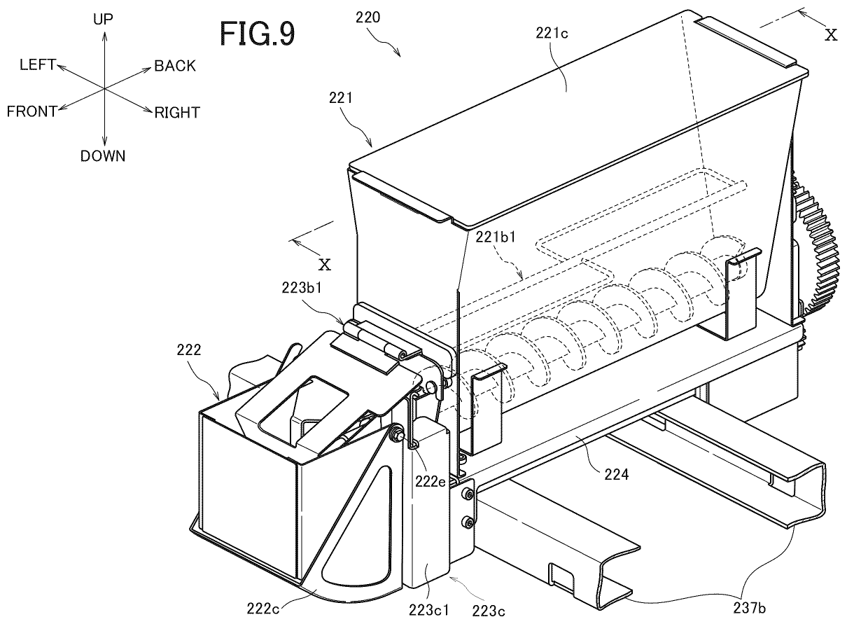

Next, a configuration of the second ingredient supply unit 220 will be described with reference to FIG. 2, FIG. 9 to FIG. 12, etc.

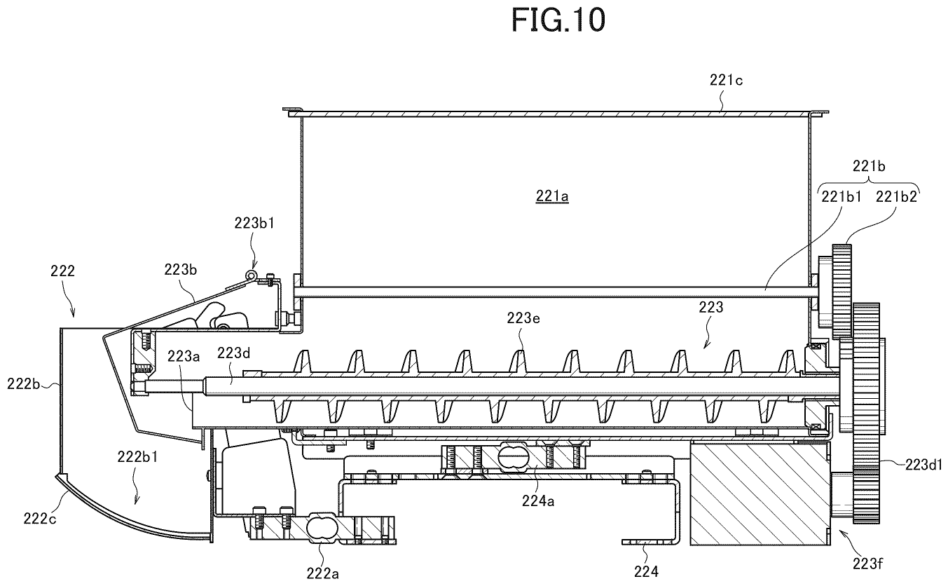

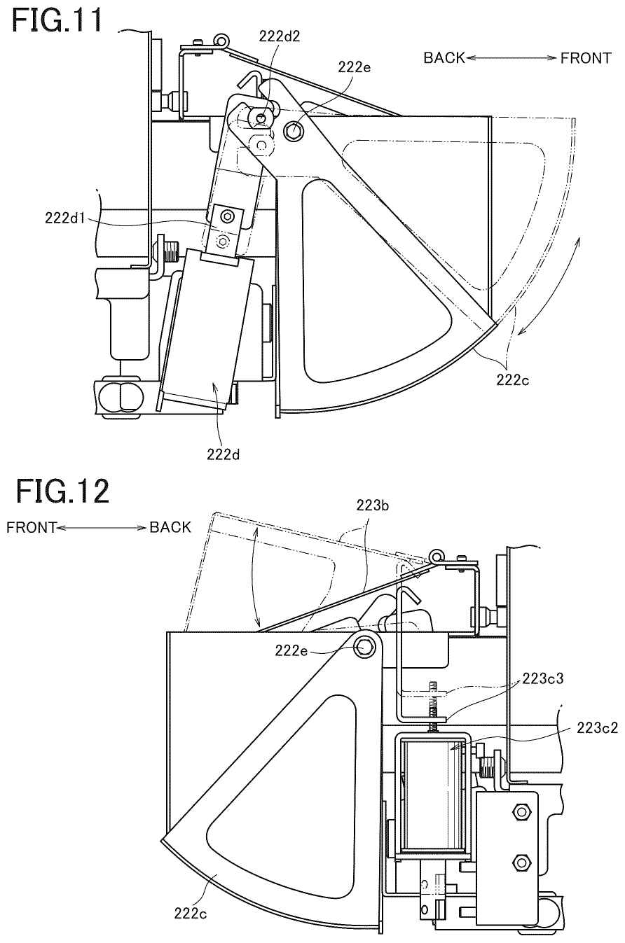

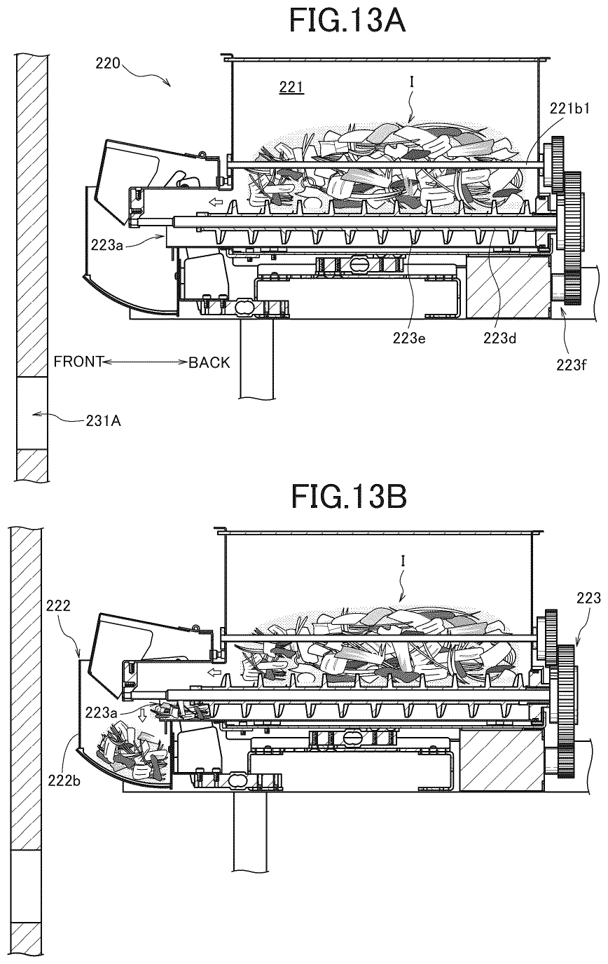

FIG. 9 is a perspective view of a second ingredient supply unit at an ingredient storage position as illustrated in FIG. 2, FIG. 10 is a cross-sectional view taken along XXII-XXII of FIG. 9, FIG. 11 is an enlarged left side view of a principal part of FIG. 9, and FIG. 12 is an enlarged right side view of a principal part of FIG. 9.

Note that in FIG. 10, the frame 237b of the slide mechanism 237 of the temperature maintenance cabinet 230 is omitted for the sake of simplicity.

Further, in FIG. 12, an exterior cover 223c1 of a shutter opening and closing mechanism 223c is omitted for the sake of explanation.

As is clear from FIG. 2, the second ingredient supply unit 220 is provided in the interior of the temperature maintenance cabinet 230.

Then, as illustrated in FIG. 9, FIG. 10, etc., this second ingredient supply unit 220 includes: an ingredient receptacle 221 provided in the interior of the temperature maintenance cabinet 230 (an upper accommodating chamber 232 and a lower accommodating chamber 233) and configured to store an ingredient; an ingredient metering means 222 for dispensing and metering an ingredient; an ingredient transfer means 223 for transferring an ingredient stored in the ingredient receptacle 221 to the ingredient metering means 222; and a rack 224 placed on the slide mechanism 237 (see FIG. 2) provided in the interior of the temperature maintenance cabinet 230 (the upper accommodating chamber 232 and the lower accommodating chamber 233), the ingredient transfer means 223 being placed on the rack 224.

Thus, the temperature of an ingredient stored in the ingredient receptacle 221 is maintained by the temperature maintenance cabinet 230.

Further, the entirety of the second ingredient supply unit 220 is drawable relative to the temperature maintenance cabinet 230 in the front-back direction, and the second ingredient supply unit 220 may be drawn further backward than the temperature maintenance cabinet 230 up to an ingredient loading position as illustrated in FIG. 2, so that an ingredient to load can be loaded into the ingredient receptacle 221.

### <5.1. Ingredient Receptacle>

As illustrated in FIG. 10, the ingredient receptacle 221 includes: a prismatic receptacle body 221a for storing an ingredient; an ingredient transfer auxiliary mechanism 221b provided at a bottom portion of this receptacle body 221a and configured to transfer an ingredient to the ingredient transfer means 223; and a detachable lid 221c for closing an upper opening formed in the receptacle body 221a.

As illustrated in FIG. 9 and FIG. 10, the ingredient transfer auxiliary mechanism 221b includes a stir shaft 221b1 configured to penetrate through the interior of the receptacle body 221a and a gear 221b2 mounted on a back end of this stir shaft 221b1.

The stir shaft 221b1 includes a shaft body configured to extend in the front-back direction and two C-shaped projecting portions configured to radially project from this shaft body, and is rotatable by means of rotation of the screw drive mechanism 223f as described below.

### <5.2. Ingredient Metering Means>

As illustrated in FIG. 9 and FIG. 10, the ingredient metering means 222 includes: a load cell 222a having a back end attached to the rack 224; a prismatic ingredient dispensing portion 222b to which a front end of this load cell 222a is attached, the prismatic ingredient dispensing portion 212b being configured to temporarily store an ingredient; a lower shutter 222c for opening and closing the ingredient supply port 222b1 of this ingredient dispensing portion 222b; and a shutter opening and closing mechanism 222d for controlling opening and closing of this lower shutter 222c.

As illustrated in FIG. 10, the load cell 222a is configured to extend in the front-back direction and detect a weight of the ingredient dispensing portion 222b.

The ingredient dispensing portion 222b has a back side notched in a U-shape such that an ingredient receiver 223a of the ingredient transfer means 223 can be inserted.

As illustrated in FIG. 9, FIG. 11, and FIG. 12, the lower shutter 222c is axially supported by a rotation shaft 222e inserted in both sides of the ingredient dispensing portion 222b, and is rotatable in the up-down direction.

As illustrated in FIG. 11, the shutter opening and closing mechanism 222d includes: a pull-type solenoid 222d1 having a plunger configured to extend and retract in the up-down direction; and a coupling pin 222d2 provided at a distal end of a plunger of this solenoid 222d1 and configured to couple to the lower shutter 222c, and is attached backward of the ingredient dispensing portion 222b.

Then, this shutter opening and closing mechanism 222d allows the plunger of the solenoid 222d1 to extend and retract, thereby allowing the coupling pin 222d2 to move vertically so as to rotate the lower shutter 222c about the rotation shaft 222e.

Specifically, when the plunger of the solenoid 222d1 extends, then the coupling pin 222d2 ascends, which results in a closed state in which the lower shutter 222c closes the ingredient supply port 222b2 to hold an ingredient.

Note that when an ingredient is placed on the lower shutter 222c, a dead weight of the ingredient is applied vertically downward to the lower shutter 222c, and a moment applied on the lower shutter 222c due to this dead weight of an ingredient is a moment in such a direction as to allow the lower shutter 222c to be in a closed state.

Further, when the plunger of the solenoid 222d1 retracts, then the coupling pin 222d2 descends, which results in an open state in which the lower shutter 222c allows the ingredient supply port 212b2 to be opened.

### <5.3. Ingredient Transfer Means>

As illustrated in FIG. 9 and FIG. 10, the ingredient transfer means 223 includes: a distal end opening 223a located frontward of the ingredient receptacle 221, the distal end opening 223a having a U-shape in front cross-sectional view; an upper shutter 223b for opening and closing this distal end opening 223a; and a shutter opening and closing mechanism 223c for controlling opening and closing of this upper shutter 223b.

Further, as illustrated in FIG. 10, this ingredient transfer means 223 includes a screw shaft 223d configured to penetrate through the interior of the ingredient receptacle 221 in the front-back direction, a spiral blade 223e attached to this screw shaft 223d, and a screw drive mechanism 223f for rotating the screw shaft 223d.

The upper shutter 223b is arranged between the distal end opening 223a which is a downstream end of the ingredient transfer means 223 and the ingredient metering means 222 and, as illustrated in FIG. 9 and FIG. 10, the upper shutter 223b is rotatable about a hinge 223b1 in the up-down direction and can close the distal end opening 223a.

As illustrated in FIG. 9, the shutter opening and closing mechanism 223c has a back end attached to the rack 224.

Then, this shutter opening and closing mechanism 223c includes: the exterior cover 223c1 as illustrated in FIG. 9; a push-type solenoid 223c2 which is configured to extend in an energized state and retract in a non-energized state; a push member 223c3 attached to a plunger of this solenoid 223c2 and vertically movable as illustrated in FIG. 11.

In the shutter opening and closing mechanism 223c thus configured, the solenoid 223c2 moves vertically so as to rotate the upper shutter 223b in the up-down direction.

Specifically, when the plunger of the solenoid 223c2 extends, then the push member 223c3 ascends, which results in an open state in which the upper shutter 223b allows the distal end opening 223a to be opened.

On the other hand, when the plunger of the solenoid 233c2 retracts, then the push member 223c3 descends, which results in a closed state in which a dead weight of the upper shutter 223b allows the distal end opening 223a to be closed to hold an ingredient.

The configuration of the upper shutter 223b as described above allows this closed state to be maintained even when an ingredient is placed on a bottom portion of the upper shutter 223b and a vertical force is applied on the bottom portion of the upper shutter 223b.

Note that this shutter opening and closing mechanism 223c is driven on the basis of a result of metering an ingredient by the ingredient metering means 222.

In other words, the upper shutter 223b adjusts a transfer amount of an ingredient to the ingredient metering means 222 on the basis of a result of metering an ingredient by the ingredient metering means 222.

The screw shaft 223d has a back end provided with a gear 223d1.

This gear 223d1 has a two-stage configuration: one engages a gear 221b2 mounted on the back end of the stir shaft 221b1 of the ingredient receptacle 221; and the other engages the screw drive mechanism 223f.

Note that teeth of the gear 223d1 which engage the gear 221b2 are provided not entirely but only partially around the circumference.

Accordingly, the stir shaft 221b1 of the ingredient receptacle 221 rotates intermittently.

As illustrated in FIG. 10, the screw drive mechanism 223f engages the gear 223d1 of the screw shaft 223d.

### <5.4. Rack>

As illustrated in FIG. 10, the rack 224 is provided with a load cell (storage weight metering means) 224a for metering a weight of an ingredient I stored in the ingredient receptacle 221 and the ingredient transfer means 223.

Note that the second ingredient supply unit 220 may be provided with a notification means (for example, an alarm) or a display means (for example, a display) for communicating that a weight of the ingredient I stored in the ingredient receptacle 221 and the ingredient transfer means 223 becomes less than or equal to a predetermined weight on the basis of the load cell 224a.

### <6. Ingredient Supply Process Through Second Ingredient Supply Unit>

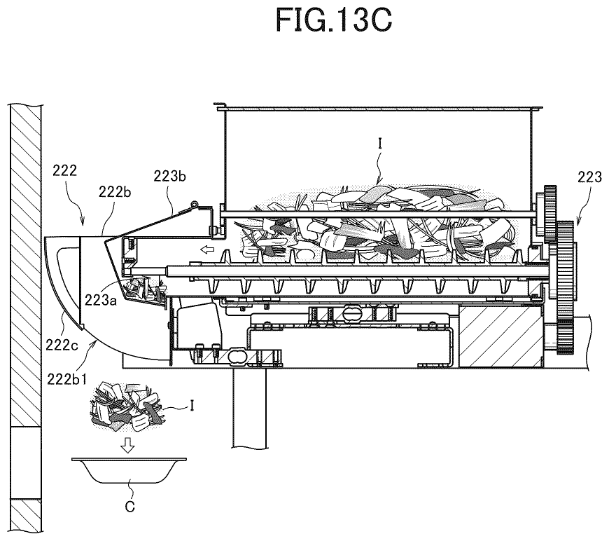

Next, an example of an ingredient supply process through the second ingredient supply unit 220 will be described with reference to FIG. 13A to FIG. 13C, etc.

FIG. 13A is a cross-sectional view illustrating a state in which a second ingredient supply unit stores an ingredient, FIG. 13B is a cross-sectional view illustrating a state in which in the second ingredient supply unit, an ingredient is dispensed into an ingredient dispensing portion, and FIG. 13C is a cross-sectional view illustrating a state in which in the second ingredient supply unit, an ingredient is supplied to a container.

Note that the ingredient supply process as described below is merely an example, and an ingredient supply process through the second ingredient supply unit 220 is not to be limited to this example.

As illustrated in FIG. 13A, the ingredient receptacle 221 of the second ingredient supply unit 220 stores the ingredient I.

From this state, the screw shaft 223d is rotated by the screw drive mechanism 223f to rotate the blade 223e, whereby the ingredient I is transferred forward toward the distal end opening 223a.

Then, in conjunction with this, the stir shaft 221b1 also rotates.

While the ingredient I is transferred toward the distal end opening 223a, as illustrated in FIG. 13A, the upper shutter 223b of the ingredient transfer means 223 is open, and the distal end opening 223a and the ingredient dispensing portion 222b of the ingredient metering means 222 communicate with each other.

Thus, while the screw shaft 223d of the ingredient transfer means 223 continues to rotate, as illustrated in FIG. 13B, the ingredient I continues to be transferred to the ingredient dispensing portion 222b of the ingredient metering means 222.

Then, until a weight of the ingredient I stored in the ingredient dispensing portion 222b of the ingredient metering means 222 reaches a supply weight according to a certain food, the ingredient transfer means 223 transfers the ingredient to the ingredient dispensing portion 222b of the ingredient metering means 222, and when an amount of the ingredient I stored in the ingredient dispensing portion 222b increases and a weight of the ingredient I stored in the ingredient dispensing portion 222b reaches a supply weight according to a certain food, as illustrated in FIG. 13C, the upper shutter 223b of the ingredient transfer means 223 is closed so as to close the distal end opening 223a.

Thereby, transfer of the ingredient I to the ingredient metering means 222 is interrupted.

Further, in addition to the behavior of the second ingredient supply unit 220 as described above, the control unit 22 in advance allows the articulated robot arm 21 to move the container C up to directly below the ingredient supply port 222b1 of the ingredient metering means 222.

Then, as illustrated in FIG. 13C, the control unit 22 allows the lower shutter 222c of the ingredient metering means 222 to open so as to open the ingredient supply port 222b1 of the ingredient metering means 222, and then from the ingredient supply port 222b1 of the ingredient dispensing portion 222b, the ingredient I having a supply weight according to a certain food is supplied to the container C.

### <7. Effects Produced by Ingredient Supply Unit and Ingredient Temperature Maintenance and Supply Device 200>

According to the ingredient supply unit (the first ingredient supply unit 210, the second ingredient supply unit 220) as described above, the upper shutter 213c, 223b configured to adjust a transfer amount of an ingredient I to the ingredient metering means 212, 222 on the basis of a result of metering the ingredient I by the ingredient metering means 212, 222 is arranged between a downstream end of the ingredient transfer means 213, 223 and the ingredient metering means 212, 222 and configured to open and close the opening (the bottom surface opening 213a1, the distal end opening 223a) formed at a distal end of the ingredient transfer means 213, 223, so that when a weight of the ingredient I dispensed in the ingredient metering means 212, 222 reaches a predetermined supply weight, the upper shutter 213c, 223b is closed and transfer of the ingredient I to the ingredient metering means 212, 222 can be stopped, which can prevent the ingredient I from spilling out from the ingredient transfer means 213, 223 to the ingredient metering means 212, 222 when a weight of the ingredient I dispensed in the ingredient metering means 212, 222 reaches a predetermined supply weight, and the ingredient I can be automatically supplied to the container C in a correct amount.

Further, the lower shutter 212c, 222c reaches a closed state by applying a vertical force on the lower shutter 212c, 222c, so that even when a dead weight of an ingredient I is applied on the lower shutter 212c, 222c while the lower shutter 212c, 222c holds the ingredient I, the lower shutter 212c, 222c does not reach an open state, and thus the ingredient I can be reliably held by the lower shutter 212c, 222c.

Moreover, there is provided the load cell 214a, 224 which is a storage weight metering means for metering an ingredient I stored in the ingredient receptacle 211, 221 and the ingredient transfer means 213, 223, so that a weight of the ingredient I stored in the ingredient receptacle 211, 221 and the ingredient transfer means 213, 223 can be determined, and thus timing of loading an ingredient I into the ingredient receptacle 211, 221 can be suitably managed.

According to the ingredient temperature maintenance and supply device 200 as described above, in addition to the effects produced by the ingredient supply unit as described above, an ingredient I maintained at a certain temperature is supplied to the container C in a predetermined amount, and thus the ingredient I can be automatically supplied to the container C in an amount required for cooking a food, while the ingredient I is maintained and stored at a suitable temperature.

### <Variations>

The ingredient supply assembly and the ingredient temperature maintenance and supply device according to an embodiment of the present invention have been described above, but the ingredient supply assembly and the ingredient temperature maintenance and supply device according to the present invention are not limited to the ingredient supply assembly and the ingredient temperature maintenance and supply device as described above.

For example, in the above embodiment, one ingredient receptacle stores a plurality of kinds of ingredients, but one ingredient receptacle may store a single kind of ingredient.

Note that the “single kind of ingredient” herein refers to an ingredient, such as grains, vegetables, seafoods, fungi, and meat, and more specifically, an ingredient, such as corns, green peas, carrots, onions, lettuce, wakame seaweed, mushrooms, minced pork, and croutons.

For example, in the above embodiment, the ingredient temperature maintenance and supply device is provided with, as the ingredient supply unit, the first ingredient supply unit and the second ingredient supply unit, but the ingredient temperature maintenance and supply device according to the present invention may be provided with either the first ingredient supply unit or the second ingredient supply unit.

For example, for a specific arrangement of the ingredient supply port of the ingredient receptacle in the ingredient temperature maintenance and supply device according to the present invention, any arrangement may be employed as long as a number of ingredient supply ports are provided for each kind of ingredients in the up-down direction and the left-right direction at the front surface of the ingredient temperature maintenance and supply device, and it is also possible to employ an arrangement in which the front surface of the ingredient temperature maintenance and supply device is slightly inclined forward or backward relative to an installation surface, such as a floor surface, an arrangement in which locations of ingredient supply ports are more or less offset in the front-back direction or a combination of these arrangements.

Note that the expression “the ingredient supply ports are provided in the up-down direction and the left-right direction at the front surface of the ingredient temperature maintenance and supply device” not only means literally that the ingredient supply ports are provided in the up-down direction and the left-right direction at the front surface of the ingredient temperature maintenance and supply device, but also means that a plurality of ingredient supply ports are provided substantially in a column in the up-down direction at the front surface of the ingredient temperature maintenance and supply device and that a plurality of ingredient supply ports are provided substantially in a row in the left-right direction at the front surface of the ingredient temperature maintenance and supply device.

For example, in the above embodiment, when a weight of an ingredient dispensed in the ingredient metering means reaches a supply weight according to a certain food, the shutter of the ingredient transfer means is closed so as to close the bottom surface opening of the distal end ingredient receiver, but the shutter of the ingredient transfer means may adjust a control amount of transferring an ingredient to the ingredient metering means by adjusting a degree of opening on the basis of a result of metering the ingredient by the ingredient metering means.

In other words, the shutter configured to adjust a transfer amount of the ingredient from the ingredient transfer means to the ingredient metering means on the basis of a result of metering the ingredient by the ingredient metering means is arranged between a downstream end of the ingredient transfer means and the ingredient metering means, so that when a weight of the ingredient stored in the ingredient metering means reaches a supply weight according to a certain food, the shutter is closed and transfer of the ingredient to the ingredient metering means can be stopped, which can prevent the ingredient from spilling out from the ingredient transfer means to the ingredient metering means when a weight of the ingredient stored in the ingredient metering means reaches a supply weight according to a certain food, and the ingredient can be automatically supplied to a cooking container in a correct amount.

For example, in the above embodiment, the shutter opening and closing mechanism 213d of the ingredient transfer means 213 is attached to the fixing frame 238 of the temperature maintenance cabinet 230, but it is also possible that the shutter opening and closing mechanism of the first ingredient supply unit is not attached to the temperature maintenance cabinet but to any member of the first ingredient supply unit.

### REFERENCE SIGNS LIST

20 ingredient supply assembly
21 articulated robot arm
21a robot arm body
21b container holding mechanism
22 control unit
200 ingredient temperature maintenance and supply device
210 first ingredient supply unit (ingredient supply unit)
211 ingredient receptacle
211a receptacle body
211b ingredient transfer auxiliary mechanism
211b1 bladed shaft
211b2 gear
211c lid
212 ingredient metering means
212a load cell
212b ingredient dispensing portion
212b1 upper opening
212b2 ingredient supply port
212c lower shutter
212c1 left shutter
212c2 right shutter
212d shutter opening and closing mechanism
212d1 solenoid
212d2 push-down member
212e left coupling pin
212e1 left-front coupling pin
212e2 left-back coupling pin
212f back coupling pin
212f1 right-front coupling pin
212f2 right-back coupling pin
213 ingredient transfer means
213a ingredient receiver
213a1 bottom surface opening (opening)
213b lid
213c upper shutter
213c1 left shutter (first shutter plate)
213c2 right shutter (second shutter plate)
213d shutter opening and closing mechanism
213d1 exterior cover
213d2 solenoid
213d3 push-down member
213d4 link
213e shutter coupling pin
213f screw shaft
213g blade
213h screw drive mechanism
214 rack
214a load cell (storage weight metering means)
220 second ingredient supply unit (ingredient supply unit)
221 ingredient receptacle
221a receptacle body
221b ingredient transfer auxiliary mechanism
221b1 stir shaft
221b2 gear
221c lid
222 ingredient metering means
222a load cell
222b ingredient dispensing portion
222b1 ingredient supply port
222c lower shutter
222d shutter opening and closing mechanism
222d1 solenoid
222d2 coupling pin
222e rotation shaft
223 ingredient transfer means
223a distal end opening (opening)
223b upper shutter
223b1 hinge
223c shutter opening and closing mechanism
223c1 exterior cover
223c2 plunger
223c3 push member
223d screw shaft
223d1 gear
223e blade
223f screw drive mechanism
224 rack
224a load cell (storage weight metering means)
230 temperature maintenance cabinet
230a front wall
230a1 opening
231 front door
231a door body
231b door rotating mechanism
232 upper accommodating chamber
233 lower accommodating chamber
234 partition plate
235 back upper door
236 back lower door
237 slide mechanism
237a supply unit-side rail
237b frame
237c handle
238 fixing frame
240 controller
C container
F floor surface
B1 coupling bolt
B2 connecting bolt
Wi ingredient receiver inner width
øf blade diameter

1. An ingredient supply unit comprising:
an ingredient receptacle for storing an ingredient;
an ingredient meter for dispensing and metering the ingredient; and
an ingredient transferor for transferring an ingredient stored in the ingredient receptacle to the ingredient meter,
wherein until a weight of the ingredient dispensed in the ingredient meter reaches a predetermined supply weight, the ingredient transferor is configured to transfer the ingredient from the ingredient receptacle to the ingredient meter, and when a weight of the ingredient dispensed in the ingredient meter reaches a predetermined supply weight, the ingredient meter is configured to supply the ingredient to a container, characterized in that
the ingredient transferor includes:
an upper shutter arranged between a downstream end of the ingredient transferor and the ingredient meter and configured to adjust a transfer amount of the ingredient from the ingredient transferor to the ingredient meter on the basis of a result of metering the ingredient by the ingredient meter; and
a shutter opening and closing mechanism for controlling opening and closing of the upper shutter in such a manner as to be in a closed state in which a dead weight of the upper shutter allows an opening formed at a distal end of the ingredient transferor to be closed to hold the ingredient or in an open state in which the opening is opened to drop and transfer the ingredient into the ingredient meter,
the upper shutter is configured to reach an open state when the shutter opening and closing mechanism is energized and reach a closed state when the shutter opening and closing mechanism is not energized, and
the upper shutter is configured such that even when the ingredient is placed on a bottom portion of the upper shutter and a vertical force is applied on the bottom portion of the upper shutter, the closed state is maintained.

2. An ingredient supply unit comprising:
an ingredient receptacle for storing an ingredient;
an ingredient meter for dispensing and metering the ingredient; and
an ingredient transferor for transferring an ingredient stored in the ingredient receptacle to the ingredient meter,
wherein until a weight of the ingredient dispensed in the ingredient meter reaches a predetermined supply weight, the ingredient transferor is configured to transfer the ingredient from the ingredient receptacle to the ingredient meter, and when a weight of the ingredient dispensed in the ingredient meter reaches a predetermined supply weight, the ingredient meter is configured to supply the ingredient to a container, characterized in that
the ingredient meter includes a tubular ingredient dispensing portion for temporarily storing the ingredient,
the ingredient transferor includes:
an ingredient receiver attached below the ingredient receptacle and configured to extend up to above the ingredient dispensing portion;
an upper shutter arranged between a downstream end of the ingredient transfer means and the ingredient meter and configured to adjust a transfer amount of the ingredient from the ingredient transferor to the ingredient meter on the basis of a result of metering the ingredient by the ingredient meter; and
a shutter opening and closing mechanism for controlling opening and closing of the upper shutter in such a manner as to be in a closed state in which a dead weight of the upper shutter allows a bottom surface opening of the ingredient receiver to be closed to hold the ingredient or in an open state in which the bottom surface opening is opened to drop and transfer the ingredient into the ingredient meter, and
the upper shutter includes:
a first shutter plate having an arc-shaped bottom portion along the bottom surface opening of the ingredient receiver;
a second shutter plate having an arc-shaped bottom portion along the bottom surface opening of the ingredient receiver; and
a shutter coupling pin for coupling an upper part of the first shutter plate and an upper part of the second shutter plate to each other and axially supporting the upper part of the first shutter plate and the upper part of the second shutter plate in a rockable manner, and is configured to reach the closed state when a weight of the ingredient reaches a predetermined supply weight, so as to close the bottom surface opening of the ingredient receiver even when the ingredient is placed on the upper shutter.

3. An ingredient supply unit comprising:
an ingredient receptacle for storing an ingredient;
an ingredient meter for dispensing and metering the ingredient; and
an ingredient transferor for transferring an ingredient stored in the ingredient receptacle to the ingredient meter,
wherein until a weight of the ingredient dispensed in the ingredient meter reaches a predetermined supply weight, the ingredient transferor is configured to transfer the ingredient from the ingredient receptacle to the ingredient meter, and when a weight of the ingredient dispensed in the ingredient meter reaches a predetermined supply weight, the ingredient meter is configured to supply the ingredient to a container, characterized in that
the ingredient transferor includes:
an upper shutter arranged between a downstream end of the ingredient transferor and the ingredient meter and configured to adjust a transfer amount of the ingredient from the ingredient transferor to the ingredient meter on the basis of a result of metering the ingredient by the ingredient meter; and
a shutter opening and closing mechanism for controlling opening and closing of the upper shutter in such a manner as to be in a closed state in which a dead weight of the upper shutter allows a distal end opening located frontward of the ingredient receptacle and opening in a transfer direction of the ingredient to be closed to hold the ingredient or in an open state in which the distal end opening is opened to drop and transfer the ingredient into the ingredient meter, and
the upper shutter is configured to reach the closed state when a weight of the ingredient reaches a predetermined supply weight, so as to close the distal end opening located frontward of the ingredient receptacle even when the ingredient is placed on the upper shutter.

4. The ingredient supply unit of claim 1, characterized in that the ingredient meter includes a lower shutter for opening and closing an ingredient supply port for supplying the ingredient to the container,
the lower shutter closes the ingredient supply port to hold the ingredient in a closed state and opens the ingredient supply port to supply the ingredient to the container in an open state, and
the lower shutter reaches a closed state by applying a vertical force on the lower shutter.

5. The ingredient supply unit of claim 1, characterized by being provided with a storage weight meter for metering an ingredient stored in the ingredient receptacle and the ingredient transferor.

6. The ingredient supply unit of claim 1 further comprising an ingredient temperature maintenance and supply device, including a temperature maintenance cabinet configured to incorporate the ingredient supply unit and store the ingredient stored in the ingredient supply unit under a temperature-maintained state.

7. The ingredient supply unit of claim 2, characterized in that the ingredient meter includes a lower shutter for opening and closing an ingredient supply port for supplying the ingredient to the container,
the lower shutter closes the ingredient supply port to hold the ingredient in a closed state and opens the ingredient supply port to supply the ingredient to the container in an open state, and
the lower shutter reaches a closed state by applying a vertical force on the lower shutter.

8. The ingredient supply unit of claim 2, characterized by being provided with a storage weight meter for metering an ingredient stored in the ingredient receptacle and the ingredient transferor.

9. The ingredient supply unit of claim 2 further comprising an ingredient temperature maintenance and supply device, including a temperature maintenance cabinet configured to incorporate the ingredient supply unit and store the ingredient stored in the ingredient supply unit under a temperature-maintained state.

10. The ingredient supply unit of claim 3, characterized in that the ingredient meter includes a lower shutter for opening and closing an ingredient supply port for supplying the ingredient to the container,
the lower shutter closes the ingredient supply port to hold the ingredient in a closed state and opens the ingredient supply port to supply the ingredient to the container in an open state, and
the lower shutter reaches a closed state by applying a vertical force on the lower shutter.

11. The ingredient supply unit of claim 3, characterized by being provided with a storage weight meter for metering an ingredient stored in the ingredient receptacle and the ingredient transferor.

12. The ingredient supply unit of claim 3 further comprising an ingredient temperature maintenance and supply device, including a temperature maintenance cabinet configured to incorporate the ingredient supply unit and store the ingredient stored in the ingredient supply unit under a temperature-maintained state.
